(19) United States
(12) Patent Application Publication
(10) Pub. No.: US 2006/0203496 A1
(43) Pub. Date: Sep. 14, 2006

(54) Discharge lamp with reflector

(75) Inventor: Takayuki Nabeshima, Yokohama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Patent-Treuhand-Gesellschaft fur Elektrische Gluhlampen mbH, Munich (DE)

(21) Appl. No.: 11/372,338

(22) Filed: Mar. 9, 2006

(30) Foreign Application Priority Data
Mar. 14, 2005 (JP) 2005-70379

(51) Int. Cl. F21V 7/00

(52) U.S. Cl. 362/341

(57) ABSTRACT

In order to provide a discharge lamp with reflector in which there is little fear that clouding on the interior surface of the reflector will occur as a result of the flow of silicone adhesive on to the interior surface of the reflector, the following means sure used: In the discharge lamp with reflector pertaining to this invention, which constitutes a discharge lamp with reflector in which a light-emitting tube is housed in the reflector interior, and in which a protective glass, provided in such a way as to cover the front face open part of the abovementioned reflector, is fixed to the abovementioned reflector using a silicone adhesive, a recessed part for suppressing the flow of the abovementioned silicone adhesive into the abovementioned reflector interior is provided in the circumferential direction in the surface of the abovementioned reflector front face on which the abovementioned protective glass is affixed using said silicone adhesive.

### TECHNICAL FIELD

The invention relates to a discharge lamp with reflector employed as a light source for a projector as described in the precharacteristing part of claim 1.

### BACKGROUND ART

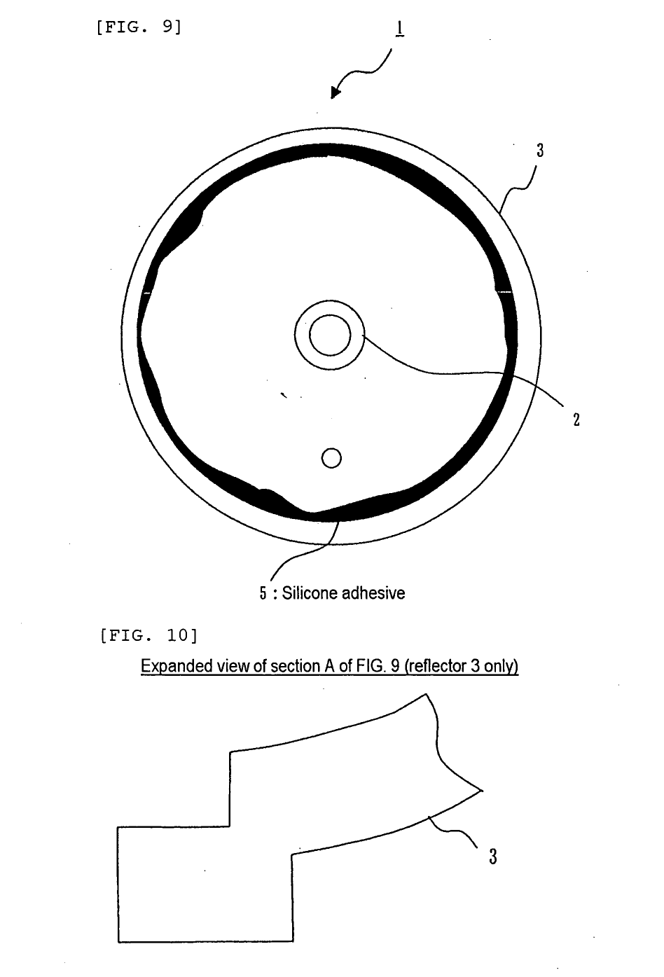

FIGS. 8 and 9 show an example of a discharge lamp with reflector of the prior art, for example Japanese Unexamined Patent Application No.2002-319310. The light-emitting component of a light-emitting tube 2 of a discharge lamp with reflector 1 is located at the focal point of the reflector 3, and the irradiated light reflected by a reflector film coated on the interior surface of the reflector 3 is irradiated to the front of the lamp. The irradiated incident light falls on an optical system provided in front of the lamp. A protective glass 4 affixed to the front surface of the reflector 3 protects against the scattering of glass fragments to the exterior should the light-emitting tube 2 break. The protective glass 4 is fixed to the reflector 3 using a silicone adhesive 5.

### DISCLOSURE OF THE INVENTION

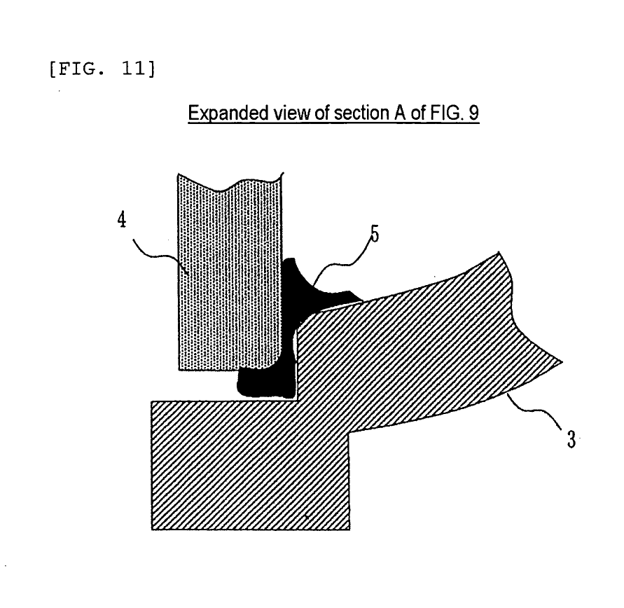

It is an object of the present invention to create a discharge lamp as described in the precharacteristing part of claim 1 which avoids the disadvantages of the prior art. As shown in FIG. 11, in the discharge lamp with reflector 1 of the prior art the silicone adhesive 5 used for the fixing of the protective glass 4 flows out and attaches to the interior surface of the reflector 3. This is because, as shown in FIG. 10, the bonding surface between the protective glass 4 and the reflector 3 is a flat surface and there is nothing to prevent the silicone adhesive 5 from diffusing on to the interior surface of the reflector 3.

The lighting of the lamp causes the temperature of the silicone adhesive 5 that has flowed into the interior surface of the reflector 3 to rise. As a result, the low molecular weight siloxane contained in the silicone adhesive 5 volatilizes and subsequently attaches to and causes clouding on the interior surface of the reflector 3. The resultant problems are a reduction in the reflectance of the interior surface of the reflector 3 and a reduction in the light irradiated to the front of the lamp.

An object of the invention, which is designed to resolve these problems, is to provide a discharge lamp with reflector in which there is little fear that a clouding of the interior surface of the reflector will occur as a result of the flow of silicone adhesive on to the interior surface of the reflector.

This object is achieved by the characterizing features of claim 1. Particularly advantageous refinements will be found in the dependent claims. In the discharge lamp with reflector pertaining to the this invention, which constitutes a discharge lamp with reflector in which a light-emitting tube is housed in the reflector interior, and in which a protective glass, provided in such a way as to cover the front face open part of the abovementioned reflector, is fixed to the abovementioned reflector using a silicone adhesive, a recessed part for suppressing the flow of the abovementioned silicone adhesive into the abovementioned reflector interior is provided in the circumferential direction in the surface of the abovementioned reflector front face on which the abovementioned protective glass is affixed using said silicone adhesive.

In the discharge lamp with reflector pertaining to this invention of the configuration described above there is little fear that a clouding of the interior surface of the reflector will occur as a result of the flow of silicone adhesive on to the interior surface of the reflector.

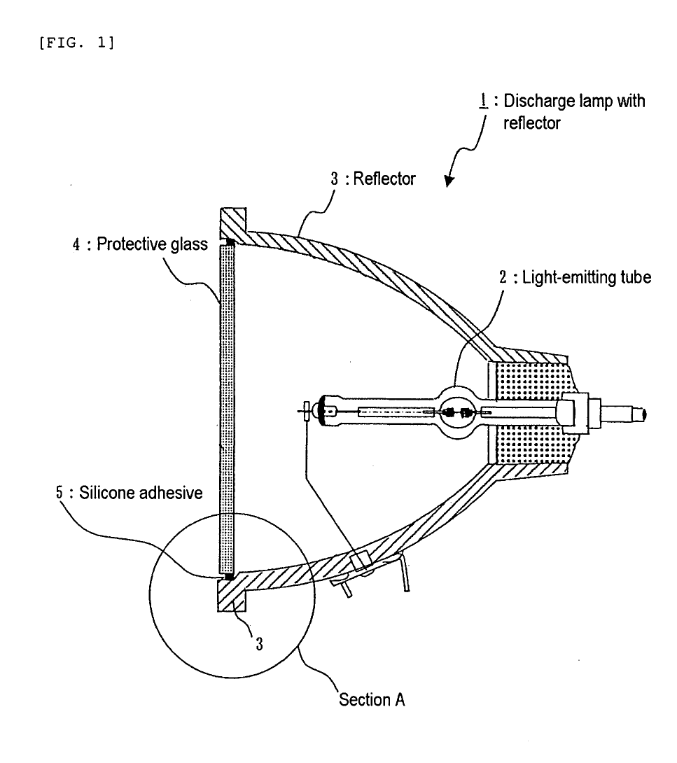

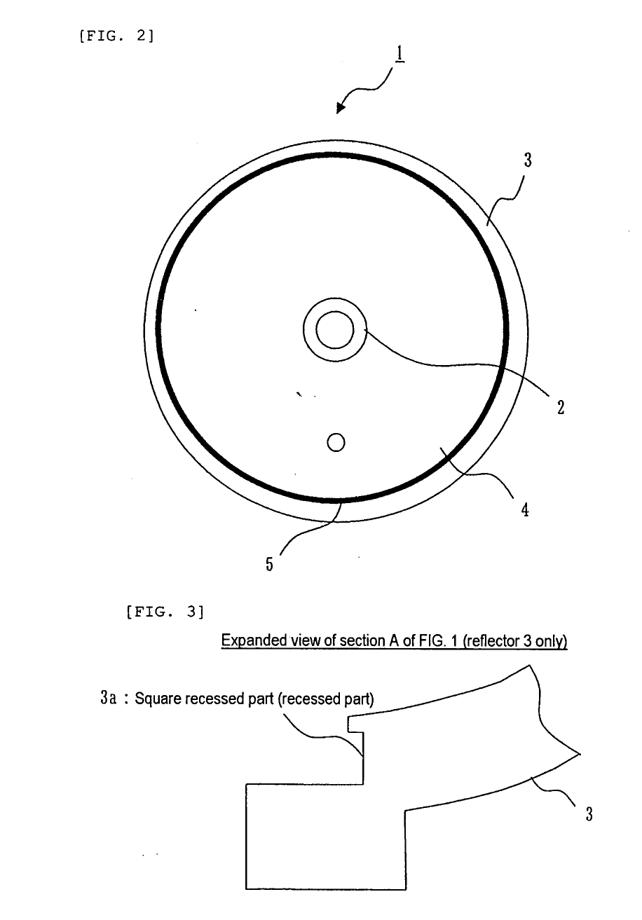

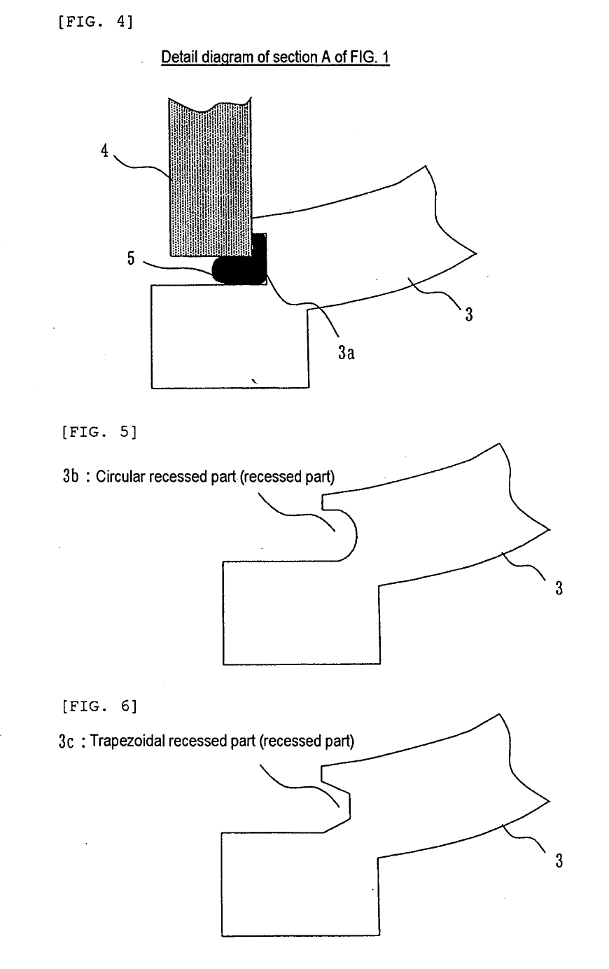

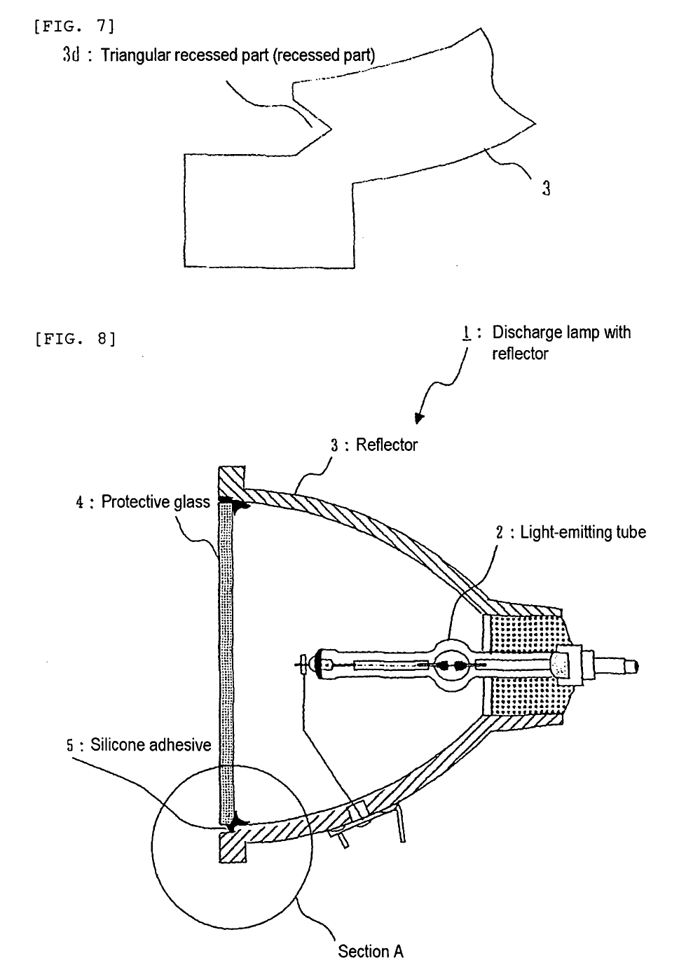

### BRIEF DESCRIPTION OF THE DRAWINGS

[FIG. 1] is a cross-sectional view of a discharge lamp with reflector of embodiment 1 of the invention;

[FIG. 2] is a front view of the discharge lamp with reflector of embodiment 1 of the invention;

[FIG. 3] is an expanded view of section A of FIG. 1 (reflector only);

[FIG. 4] is a detail diagram of section A of FIG. 1;

[FIG. 5] is a diagram of a modified example of the reflector recessed part of embodiment 1 of the invention;

[FIG. 6] is a diagram of a modified example of the reflector recessed part of embodiment 1 of the invention;

[FIG. 7] is a diagram of a modified example of the reflector recessed part of embodiment 1 of the invention [FIG. 8] is a cross-sectional view of a discharge lamp with reflector of the prior art;

[FIG. 9] is a front view of a discharge lamp with reflector of the prior art;

[FIG. 10] is an expanded view of section A of FIG. 9 (reflector only); and

[FIG. 11] is a detail diagram of section A of FIG. 9.

### BEST MODE FOR CARRYING OUT THE INVENTION

FIGS. 1 to 7 represent diagrams of embodiment mode 1. FIG. 1 is a cross-sectional view of a discharge lamp with reflector, FIG. 2 is a front view of the discharge lamp with reflector, FIG. 3 is an expanded view of section A of FIG. 1 (reflector only), FIG. 4 is a detail diagram of section A of FIG. 1, and FIGS. 5 to 7 are diagrams of modified examples of the recessed part of the reflector. In FIGS. 1 and 2, an Embodiment mode is shown. The light-emitting component of a light-emitting tube 2 of a discharge lamp with reflector 1 is located at the focal point of the reflector 3, and the irradiated light reflected by a reflector film coated on the interior surface of the reflector 3 is irradiated to the front of the lamp. The irradiated incident light falls on an optical system provided in front of the lamp. A protective glass 4 affixed to the front surface of the reflector 3 protects against the scattering of glass fragments to the exterior should the light-emitting tube 2 break. The protective glass 4 is fixed to the reflector 3 using a silicone adhesive 5.

The silicone adhesive 5 contains low molecular weight siloxane. The low molecular weight siloxane is volatile and, when it flows on to the reflector interior 3, it attaches to and causes clouding on the interior surface of the reflector 3. Because, as a result, a reduction in the reflectance of the interior surface of the reflector 3 and a reduction in the light irradiated to the front of the lamp occurs, it is essential to prevent the flow of the silicone adhesive 5 into the reflector interior 3.

For this reason, as shown in FIG. 3, a recessed part 3a (as one example of a recessed part) in which the silicone adhesive 5 is held to prevent it from flowing into the reflector 3 interior is provided in the circumferential direction in the surface of the reflector 3 front face on which the protective glass 4 is affixed. Although the provision of a recessed part in the circumferential direction across the entire surface thereof is desirable it is not mandatory.

As shown in FIG. 4, the flow of the silicone adhesive 5 into the reflector 3 interior can be suppressed by the adoption of a configuration such as this.

Although a square recessed part 3a is shown in FIG. 3, as shown in FIGS. 5 to 7 the recessed part may be of any shape including a circular recessed part 3b, a trapezoidal recessed part 3c or a triangular recessed part 3d.

As is clear from the description given above, based on this embodiment, the flow of the silicone adhesive into the reflector 3 interior can be controlled by the provision in the surface on which the protective glass 4 of the reflector 3 front face is affixed of a square recessed part 3a, a circular recessed part 3b, a trapezoidal recessed part 3c or a triangular recessed part 3d in such a way as to hold the silicone adhesive 5 and prevent its flow into the reflector 3 interior, whereupon the volatilization of the low molecular weight siloxane of the silicone adhesive 5, which causes clouding on the interior surface of the reflector 3, can be prevented. Accordingly, there is little fear that a reduction in the reflectance of the interior surface of the reflector 3 or a reduction in the light irradiated to the front of the lamp will occur.

Explanation of Symbols 1 Discharge lamp with reflector, 2 Light-emitting tube, 3 Reflector, 3a Square recessed part, 3b Circular recessed part, 3c Trapezoidal recessed part, 3d Triangular recessed part, 4 Protective glass, 5 Silicone adhesive.

1. Discharge lamp with reflector in which a light-emitting tube is housed in the reflector interior, and in which a protective part made of glass, provided in such a way as to cover the front face open part of the abovementioned reflector, is fixed to the abovementioned reflector using a silicone adhesive, characterized in that a recessed part for suppressing the flow of the abovementioned silicone adhesive into the abovementioned reflector interior is provided in the circumferential direction in the surface of the abovementioned reflector front face on which the abovementioned protective glass is affixed using said silicone adhesive.

2. Lamp in accordance with claim 1, characterized in that the recessed part is shaped in cross-section as a Square or Circular or Trapezoidal or Triangular.
